(19) United States
(12) Patent Application Publication
(10) Pub. No.: US 2008/0175488 A1
(43) Pub. Date: Jul. 24, 2008

(54) Image processing apparatus, image forming apparatus, image forming system, computer readable medium storing program therefor, image processing method, and computer data signal

(75) Inventors: Taro Yokose, Ashigarakami-gun (JP); Tomoki Taniguchi, Ashigarakami-gun (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/889,415

(22) Filed: Aug. 13, 2007

(30) Foreign Application Priority Data
Jan. 23, 2007 (JP) 2007-012564

(51) Int. Cl. G06K 9/36

(52) U.S. Cl. 382/232

(57) ABSTRACT

An image processing apparatus includes an image partitions manipulating unit that manipulates image partitions of encoded image information, each image partition containing plural values of pixels; a decoding unit that decodes the image information manipulated by the image partitions manipulating unit; and a pixels manipulating unit that manipulates pixels of the image information decoded by the decoding unit, partitioning an image into partitions which are manipulated by the image partitions manipulating unit being changed according to what manipulation is to be performed by the pixels manipulating unit.

### CROSS-REFERENCE TO RELATED APPLICATIONS

This application is based on and claims priority under 35 USC 119 from Japanese Patent Application No. 2007-012564 filed Jan. 23, 2007.

### BACKGROUND

### Technical Field

The present invention relates to an image processing apparatus, an image forming apparatus, an image forming system, a computer readable medium storing a program therefor, an image processing method, and a computer data signal.

### SUMMARY

According to an aspect of the invention, there is provided an image processing apparatus including an image partitions manipulating unit that manipulates image partitions of encoded image information, each image partition containing plural values of pixels; a decoding unit that decodes the image information manipulated by the image partitions manipulating unit; and a pixels manipulating unit that manipulates pixels of the image information decoded by the decoding unit, partitioning an image into partitions which are manipulated by the image partitions manipulating unit being changed according to what manipulation is to be performed by the pixels manipulating unit.

### BRIEF DESCRIPTION OF THE DRAWINGS

Exemplary embodiments of the present invention will be described in detail based on the following figures, wherein:

FIG. 1 illustrates an overview of an image forming system;

FIG. 2 illustrates an organization of functions of an image processing program 5 that is executed by an image processing apparatus 2 (FIG. 1);

FIGS. 3A and 3B illustrate an image partitions manipulating part 52 (FIG. 2) in greater detail;

FIGS. 4A to 4D illustrate processing for 180-degree rotation;

FIGS. 5A to 5D illustrate processing for 90-degree rotation clockwise;

FIGS. 6A to 6D illustrate modification 1 of processing for 180-degree rotation;

FIGS. 7A to 7C illustrate modification 2 of processing for 180-degree rotation;

FIGS. 8A and 8B illustrate an overview of processing for shifting image partitions and pixels;

FIGS. 9A and 9B illustrate an organization of functions of an image portions manipulating part 62 and an organization of functions of a pixels manipulating part 66, respectively, in a second exemplary embodiment;

FIGS. 10A to 10C illustrate shift processing;

FIGS. 11A to 11D illustrate an overview of combine processing;

FIGS. 12A and 12B illustrate an organization of functions of an image portions manipulating part 72 and an organization of functions of a pixels manipulating part 76, respectively, in a third exemplary embodiment;

FIGS. 13A to 13D illustrate combine processing (merge processing) on the image partition level and on the pixel level.

FIGS. 14A and 14B illustrate an organization of functions of an image processing unit 8; and

FIG. 15 is a flowchart illustrating operation (S10) of the image processing apparatus 2 (image processing unit 8).

### DETAILED DESCRIPTION

### First Exemplary Embodiment

An image forming system in a first exemplary embodiment is outlined.

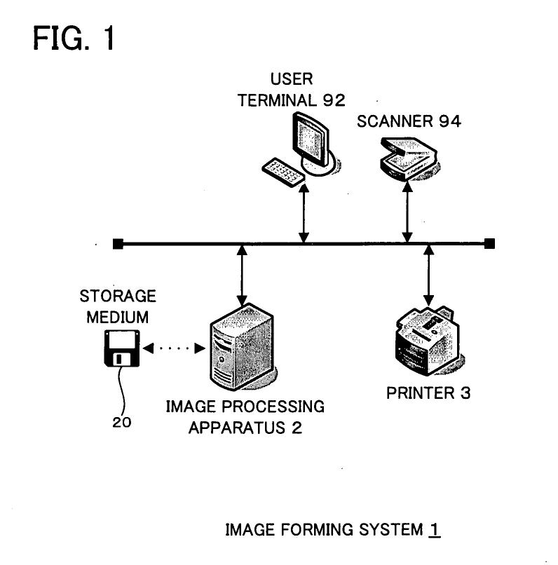

FIG. 1 illustrates an overview of an image forming system.

As illustrated in FIG. 1, an image forming system 1 includes an image processing apparatus 2 and a printer 3.

The image processing apparatus 2 is a computer. The image processing apparatus 2 of the present exemplary embodiment is connected to a network such as LAN, performs image processing on image information received from a user terminal 92 or a scanner 94, and sends the processed image information to the printer 3. An example of image processing discussed in this exemplary embodiment is rotating an input image by 90 degrees or 180 degrees.

The printer 3 is one example of an image forming apparatus. The printer 3 of the present exemplary embodiment receives image information from the image processing apparatus 2 via the network such as LAN and prints an image on imaging paper from the received image information.

The image processing apparatus 2 may be installed within the chassis of the printer 3.

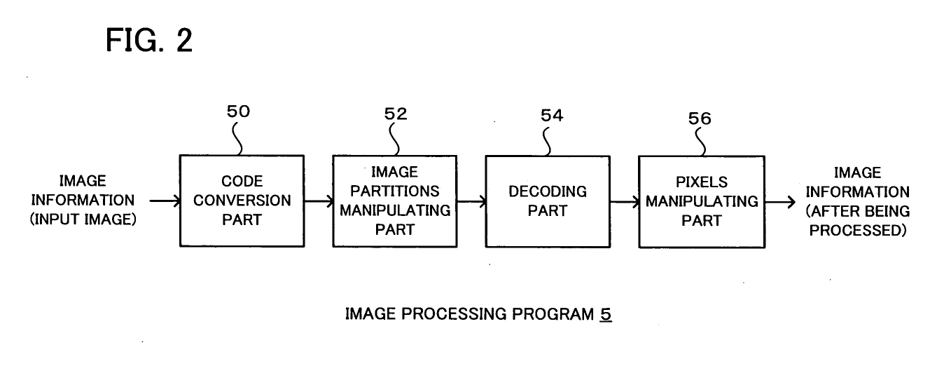

FIG. 2 illustrates an organization of functions of an image processing program 5 that is executed by the image processing apparatus 2 (FIG. 1).

As illustrated in FIG. 2, the image processing program 5 includes a code conversion part 50, an image partitions manipulating part 52, a decoding part 54, and a pixels manipulating part 56.

A part or all of the organization of the functions of the image processing program 5 is stored, for example, in a storage medium 20 (FIG. 1) and installed into the image processing apparatus 2 via the storage medium 20. The organization of the functions of the image processing program 5 may be delivered via the network and installed into the image processing apparatus 2. The image forming system 1 of the present exemplary embodiment is not limited to the framework illustrated in FIG. 1 and may be configured in different ways, provided that the modules mentioned in FIG. 2 can be executed. For example, some modules may be formed in dedicated hardware (e.g., ASIC or the like) and some modules may exist in an external system and may be linked to other modules by a communication line. Moreover, plural systems, each as illustrated in FIG. 1, may be interconnected for cooperative operation. The modules may be incorporated in a copier, a facsimile machine, a scanner 94, a printer 3, a complex machine (also called a multi-function copier having the functions of a scanner, printer, copier, facsimile machine, etc.), or the like.

In the image processing program 5, the code conversion part 50 converts input image information into code data that can be decoded independently for each of image portions (hereinafter referred to as image partitions) of predefined size. Here, the image information is a concept including uncoded values of pixels (hereinafter image data) and encoded image data.

Specifically, the code conversion part 50 in the present exemplary embodiment, if uncoded image data is input, performs independent encoding of input image data for every image partition of predefined size. The following coding methods may be applied: LZ coding, run length coding, predictive coding, frequency transform coding by discrete cosine transform (DCT) or discrete wavelet transform (DWT), etc. By defining a window size, a run range, or a processing unit of frequency transform, a code that can be decoded independently for each image partition of predefined size can be generated.

The code conversion part 50 in the present exemplary embodiment, if encoded image data is input, converts the code data into coded data that can be decoded independently for each image partition of predefined size. Such conversion is made possible by dividing the run length or by a similar manner.

The code conversion part 50 may use code words having boundaries of nibbles (four bits), bytes, words (two bytes), or the like, because separation into and merging of code words or code strings are performed in a later stage. This makes the separation or the like into code strings easy.

The image partitions manipulating part 52 manipulates image partitions of encoded image information. Since values of plural pixels exist in an image partition, the image partitions manipulating part 52 processes each code string corresponding to the values of the plural pixels of a partition included in code data. In the description of the exemplary embodiment, a set of code values corresponding to the values of all pixels contained in an image partition is referred to as a code string and a set of code values corresponding to the whole image is referred to as code data.

For code data input from the code conversion part 50, the image partitions manipulating part 52 in the present exemplary embodiment rearranges the code strings contained in the code data in a sequence to obtain an angle of rotation of the image and outputs the thus rearranged code data to the decoding part 54.

The decoding part 54 decodes the code data input from the image partitions manipulating part 52 and outputs decoded image data to the pixels manipulating part 56. The input code data can be decoded even if the sequence of the code strings has been changed, because the code data converted by the code conversion part 50 is decodable independently for each image partition.

The pixels manipulating part 56 manipulates the pixels of the image data decoded by the decoding part 54.

The pixels manipulating part 56 in the present exemplary embodiment rearranges the decoded values of the pixels in a sequence to obtain an angle of rotation of the image.

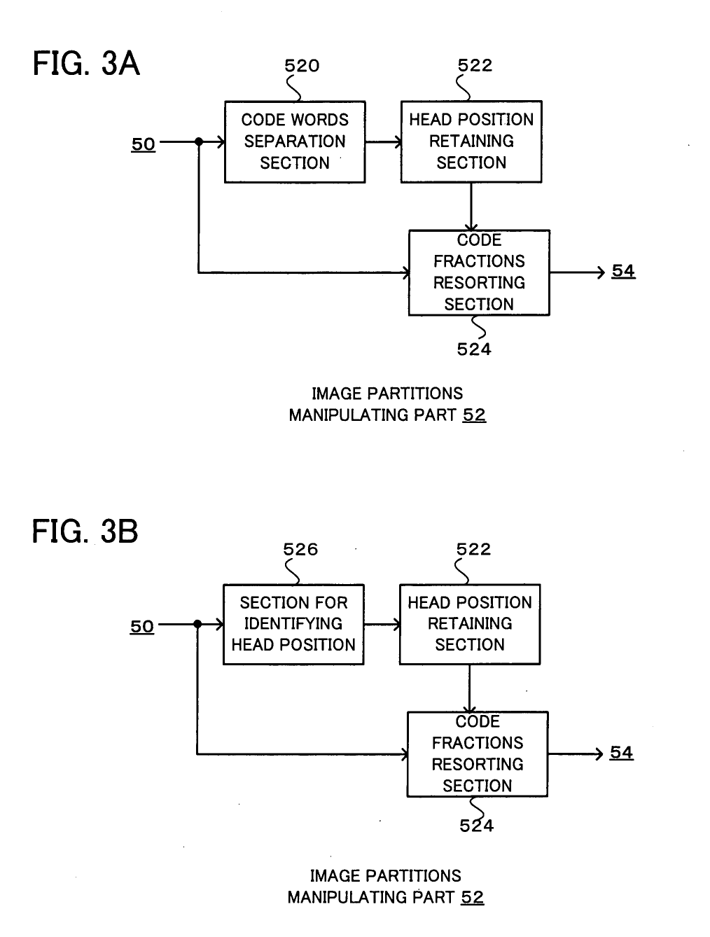

FIGS. 3A and 3B illustrate the image partitions manipulating part 52 (FIG. 2) in greater detail.

As illustrated in FIG. 3A, the image partitions manipulating part 52 includes a code words separation section 520, a head position retaining section 522, and a code fractions resorting section 524.

The code words separation section 520 separates code data into code words from the beginning of the code data, referring to a code book, and identifies the head position of each image partition. The code words separation section 520, for example, may identify the head position of each image partition, based on the number of pixels corresponding to separated code words. It may identify the head position of each image partition, based on a code (e.g., a line end code) indicating the end position of its preceding image partition.

In this way, separation into code words can be performed only if the length of a code word is known. There is no need for knowing the content (symbol) corresponding to a code word. Thus, the separation into code words can be performed at a higher speed than normal decoding processing. Although the present exemplary embodiment assumes that a variable length code is applied, the separation into code words becomes simpler if a fixed length code is applied.

The head position retaining section 522 retains the head position of an image partition (the position within code data) identified by the code words separation section 520.

The code fractions resorting section 524 resorts code strings from within the code data in an arbitrary sequence, based on the head position of each partition retained by the head position retaining section 522. The code fractions resorting section 524 in the present exemplary embodiment resorts the code strings from within the code data in a sequence to obtain an angle of rotation of the image and outputs the resorted code strings to the decoding part 54 serially.

FIG. 3B illustrates the image partitions manipulating part 52 in an instance where the code length of each code word is specified in a header or the like. When the code length of each code word is known from the header or the like, separation into code words can be performed without referring to the code book. Thus, a section for identifying head position 526 illustrated in FIG. 3B separates code data into code words, based on the code length specified in the header or the like, and identifies the head position of each image partition in the code data. If the head position of each image partition is embedded in the code data, the section for identifying head position 526 may extract the head position of each image partition from the code data and output it to the head position retaining section 522.

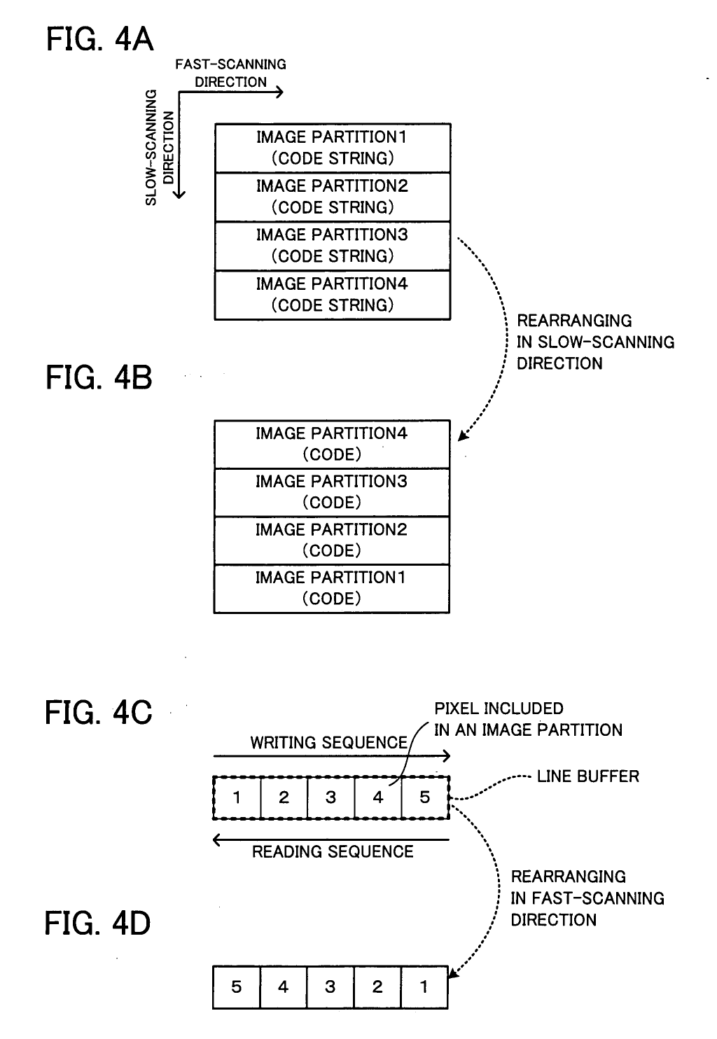

FIGS. 4A to 4D illustrate processing for 180-degree rotation.

As illustrated in FIG. 4A, the image partitions manipulating part 52 (FIG. 2) regards one line in a fast-scanning direction of an image as an image partition and divides input code data into code strings, each string corresponding to one line. In this case, the code conversion part 50 may execute conversion into code data that can be decoded independently for each line in the fast-scanning direction or code data that can be decoded independently for each of image portions into which one line in the fast-scanning direction is divided. If the code conversion part 50 defines image partitions as plural divisions of one line in the fast-scanning direction, the image partitions manipulating part 52 manipulates one-line units of these image partitions.

More specifically, the code words separation section 520 (FIG. 3A) separates the input code data into code words from the beginning, identifies the head position of each line in the fast-scanning direction (fast-scan line), and registers the head position into the head position retaining section 522. Thereby, the code fractions resorting section 524 becomes able to access the code strings of the image partitions illustrated in FIG. 4A in an arbitrary sequence.

The image partitions manipulating part 52 rearranges the code strings of the image partitions in a slow-scanning direction (vertical direction of the image), as illustrated in FIG. 4B. Consequently, the image partitions are rearranged in mirrored positions in the slow-scanning direction.

More specifically, the code fractions resorting section 524 (FIG. 3A) resorts the code strings in ascending order from the lowest line, based on the head position of each line retained by the head position retaining section 522, and outputs the resorted code strings to the decoding part 54. Thereby, the code strings are rearranged, as illustrated in FIG. 4B.

Then, the decoding part 54 serially decodes the code strings which are serially input from the image partitions manipulating part 52 (the code fractions resorting section 524) and outputs a set of decoded values of pixels to the pixels manipulating part 56. FIG. 4C illustrates an example of a set of pixels for one image partition, output from the decoding part 54. In the present exemplary embodiment, one image partition contains five pixels.

The pixels manipulating part 56 rearranges the pixels in the set of values of pixels input from the decoding part 54 in the fast-scanning direction. More specifically, the pixels manipulating part 56 writes the pixels as many as those contained in one image partition (five pixels in the present exemplary embodiment) in the set of values of pixels input from the decoding part 54 into a line buffer and reads these pixels in a sequence reverse to the writing sequence from the line buffer, as illustrated in FIG. 4C. Thereby, it is realized that the pixels contained in one line are rearranged in mirrored positions in the fast-scanning direction, as illustrated in FIG. 4D.

As above, the processing for 180-degree rotation is realized by combination of 180-degree rotation processing of image partitions (processing on codes) and 180-degree rotation processing of pixels (processing on the values of pixels).

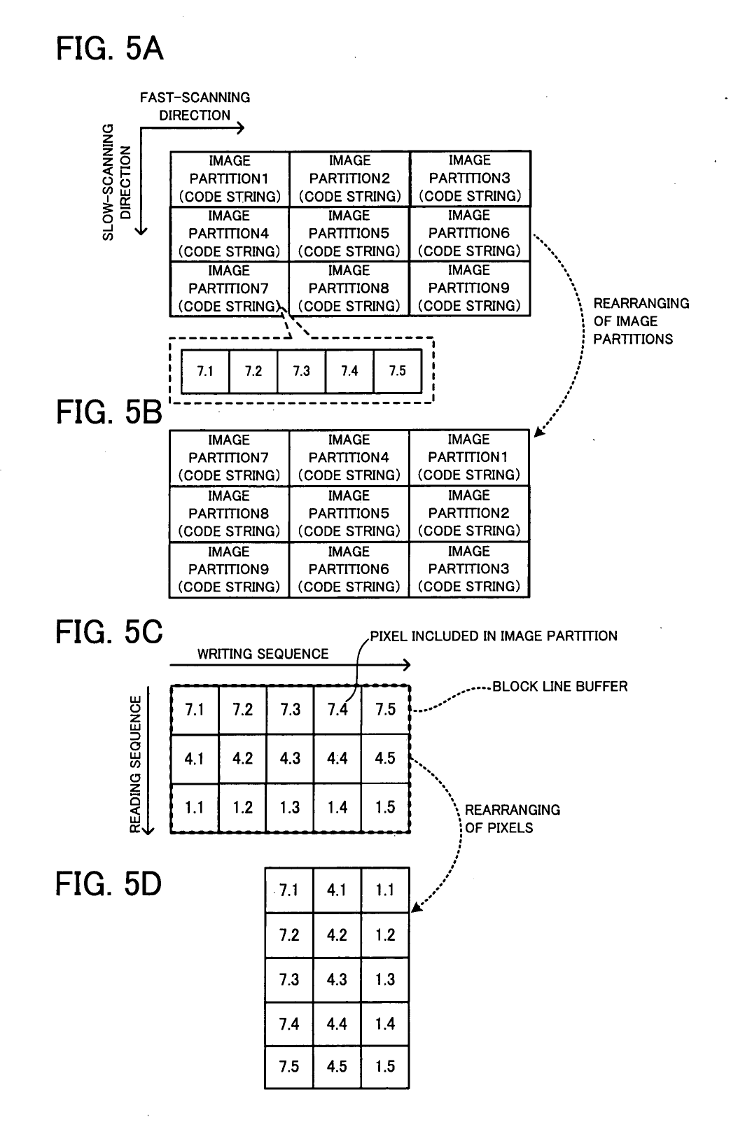

FIGS. 5A to 5D illustrate processing for 90-degree rotation clockwise.

As illustrated in FIG. 5A, image partitions may be defined as divisions of a fast-scan line for processing of 90-degree rotation. In the present exemplary embodiment, one fast-scan line is divided into three equal image portions and these portions are regarded as image partitions. In the present exemplary embodiment, five pixels are arranged in the fast-scanning direction within one image partition.

Specifically, the code words separation section 520 (FIG. 3A) separates the input code data into code words from the beginning, identifies the head position of each image partition, based on the number of pixels corresponding to a code word, and registers the head position into the head position retaining section 522. Thereby, the code fractions resorting section 524 becomes able to access the code strings of the image partitions illustrated in FIG. 5A in an arbitrary sequence.

The image partitions manipulating part 52 rearranges the codes strings of the image partitions to rotate the image by 90 degrees on the level of image partitions, as illustrated in FIG. 5B.

Specifically, the code fractions resorting section 524 (FIG. 3A) resorts the code strings of the image partitions arranged in a column in the slow-scanning direction in reverse order up to the top image partition in the column (image partition 1), shifts to the next column in the fast-scanning direction, and repeats resorting of the code strings of the image partitions arranged in the slow-scanning direction in reverse order, based on the head position of each partition retained by the head position retaining section 522. Thereby, the code strings are rearranged, as illustrated in FIG. 5B.

Then, the decoding part 54 serially decodes the code strings which are serially input from the image partitions manipulating part 52 (the code fractions resorting section 524) and outputs a set of decoded values of pixels to the pixels manipulating part 56.

The pixels manipulating part 56 rearranges the pixels in the set of values of pixels input from the decoding part 54, thereby rotating the set of values of pixels contained in each image partition by 90 degrees.

Specifically, the pixels manipulating part 56 writes sets of values of pixels in three image partitions input from the decoding part 54 into a block line buffer and reads these values in an orthogonal direction to the writing direction from the block line buffer, as illustrated in FIG. 5C. Thereby, the sets of the pixels contained in each image partition are rotated by 90 degrees, as illustrated in FIG. 5D. The block line buffer is a buffer with a capacity for image data in an area smaller than a page buffer capable of buffering one page of image data.

As above, the processing for 90-degree rotation is realized by combination of 90-degree rotation processing of image partitions (processing on codes) and 90-degree rotation processing of pixels (processing on the values of pixels).

### MODIFICATION EXAMPLES

Next, examples of modifications to the above exemplary embodiment are described.

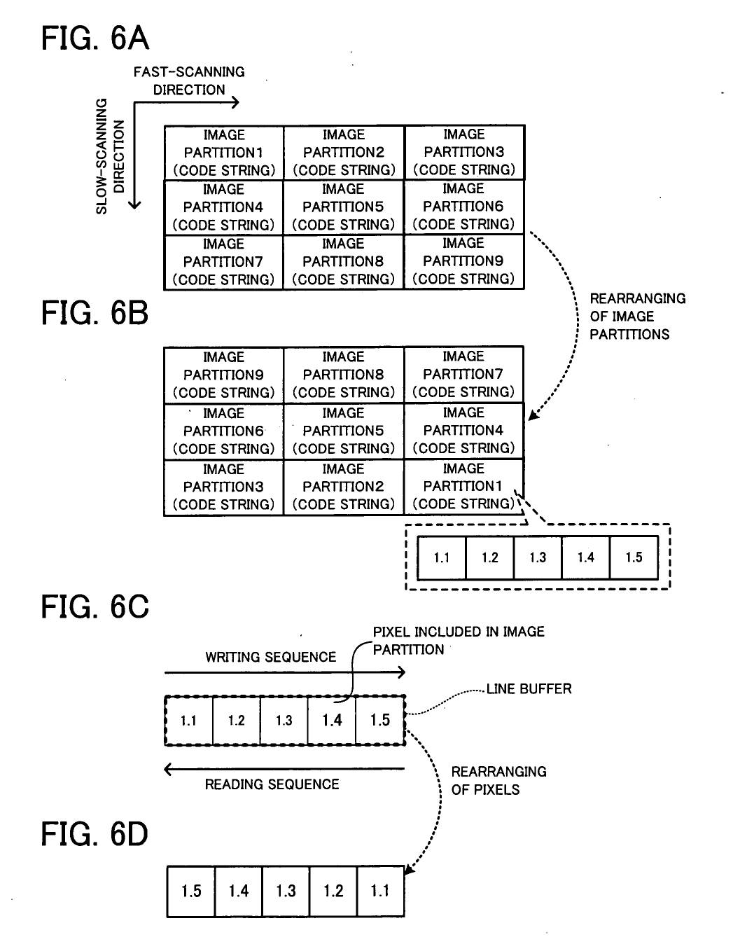

In the above exemplary embodiment, one line in the fast-scanning direction is regarded as an image partition in the case of processing for 180-degree rotation; however, image partitioning is not so limited. Image partitions may be defined as divisions of one line in the fast-scanning direction, for example, as illustrated in FIG. 6A.

In this case, the image partitions manipulating part 52 performs 180-degree rotation processing of image partitions, as illustrated in FIG. 6B. That is, in this modification example, the image partitions manipulating part 52 executes rearranging the image partitions in both mirrored positions in the fast-scanning direction and mirrored positions in the slow-scanning direction.

Then, the pixels manipulating part 56 rearranges a set of pixels within each image partition, as illustrated in FIG. 6C and FIG. 6D. In this case, because the size of a line buffer is determined by the size of an image partition, as illustrated in FIG. 6C, the line buffer can be smaller as the size of an image partition is smaller. However, in the case an image partition is defined as one whole line as in the above exemplary embodiment, the data compression ratio often becomes higher than in this modification example.

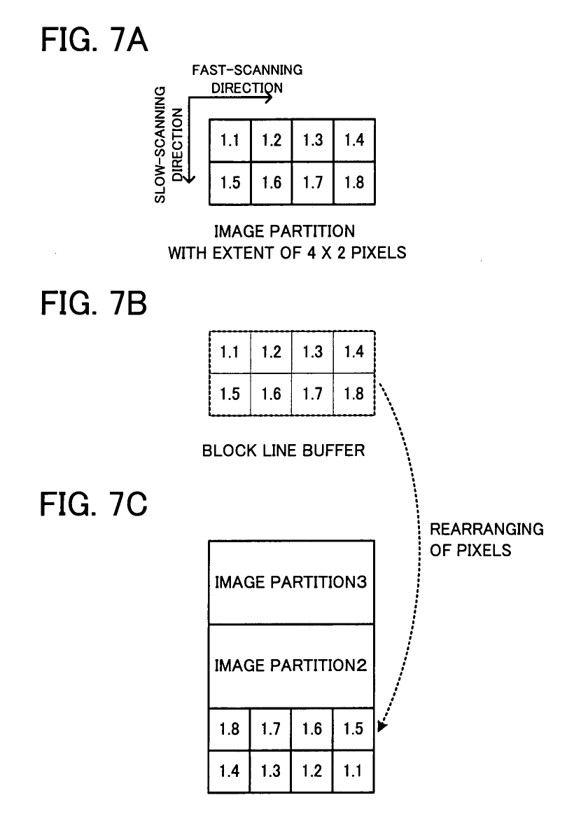

In the above exemplary embodiment, an image partition is defined to have one-pixel length in the slow-scanning direction; however, image partitioning is not so limited. An image partition may be defined to have two-pixel length in the slow-scanning direction, for example, as illustrated in FIG. 7A. In this exemplary embodiment, an image partition extends across two fast-scan lines.

In this case, the image partitions manipulating part 52 simply rearranges the image partitions in the slow-scanning direction, as is the case for the above exemplary embodiment. The pixels manipulating part 56 writes a set of pixels in an image partition into a block line buffer and reads the pixels in a sequence reverse to the writing sequence from the block line buffer, as illustrated in FIG. 7B. Thereby, the set of the pixels in the image partition is rotated by 180 degrees, as illustrated in FIG. 7C.

### Second Exemplary Embodiment

Next, an embodiment for shifting an image is described as a second exemplary embodiment.

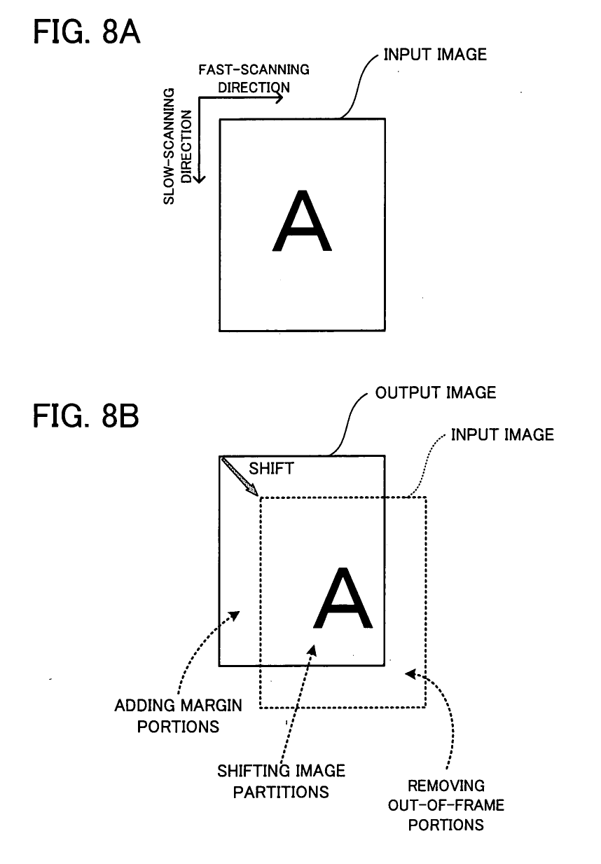

Sometimes, an input image which is illustrated in FIG. 8A may be translated (shifted) and output. Such output image is illustrated in FIG. 8B. When such shift processing is performed, it may be needed to add margin portions and remove out-of-frame portions as well as shifting pixels.

In the present exemplary embodiment, processing that is performed on the image partition level includes at least one of the following: shifting pixels, adding margin portions, and removing out-of-frame portions. Then, processing such as shifting pixels is performed on the pixel level. The framework of the image forming system 1 and relevant configurations are substantially the same as described for the first exemplary embodiment.

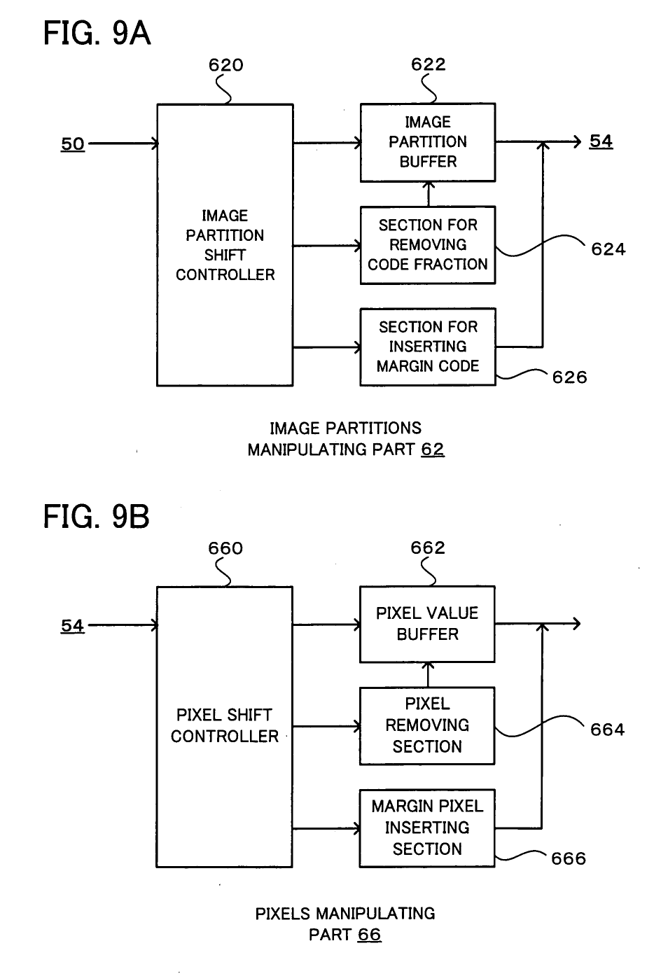

FIG. 9A illustrates an organization of functions of an image partitions manipulating part 62 in the present exemplary embodiment. FIG. 9B illustrates an organization of functions of a pixels manipulating part 66 in the present exemplary embodiment. An image processing program 6 in the present exemplary embodiment is configured such that the image partitions manipulating part 52 and the pixels manipulating part 56 in the image processing program 5 of FIG. 2 is replaced by the image partitions manipulating part 62 and the pixels manipulating part 66 in the present exemplary embodiment, respectively.

As illustrated in FIG. 9A, the image partitions manipulating part 62 includes an image partition shift controller 620, an image partition buffer 622, a section for removing code fraction 624, and a section for inserting margin code 626.

The image partition shift controller 620 controls shifting image partitions, adding margin portions, and removing out-of-frame portions, according to a shift direction and a shift amount.

The image partition shift controller 620 separates the input code data into code words and sequentially outputs the code words to the image partition buffer 622. The image partition buffer 622 stores the code words for one image partition (i.e., a code string), which are input from the image partition shift controller 620.

The image partition shift controller 620 determines whether the next image portion which is as large as an image partition is a margin portion, out-of-frame portion, or any other image portion from a shift direction and a shift amount. If the next image portion is a margin portion (a portion made up entirely of margin pixels), the controller 620 instructs the section for inserting margin code 626 to insert a margin code. If the next image portion is an out-of-frame portion (a portion made up entirely of pixels that run out of the frame), the controller 620 instructs the section for removing code fraction 624 to remove the code string of the image partition. If the next image portion is neither a margin portion nor an out-of-frame portion, the controller 620 instructs the image partition buffer 622 to output the code string held therein.

The section for removing code fraction 624, when instructed to remove the code string from the image partition shift controller 620, erases the code string held in the image partition buffer 622.

The section for inserting margin code 626, when instructed to insert a margin code from the image partition shift controller 620, outputs a code string corresponding to a margin portion for one image partition to the decoding part 54. The code string corresponding to the margin portion is a run of pixel values of 0 in the case of run length coding, which is prepared in advance.

The image partition buffer 622, when instructed to output the code string from the image partition shift controller 620, outputs the code string held therein to the decoding part 54. That is, by shifting the output timing of the code string held in the image partition buffer 622, translation of a set of pixels in an image partition is realized.

As illustrated in FIG. 9B, the pixels manipulating part 66 includes a pixel shift controller 660, a pixel value buffer 662, a pixel removing section 664, and a margin pixel inserting section 666.

The pixel shift controller 660 controls shifting pixels contained in an image partition, adding margin pixels, and removing out-of-frame pixels, according to a shift direction and a remaining amount of shift. Here, the remaining amount of shift is a value obtained by subtracting an amount of shift performed by the image partitions manipulating part 62 from a required amount of shift.

The pixel shift controller 660 in the present exemplary embodiment outputs a set of values of pixels, which has been input from the decoding part 54, to the pixel value buffer 662 serially. The pixel value buffer 662 stores a pixel value that is input from the pixel shift controller 660.

The pixel shift controller 660 determines whether the next pixel is a margin pixel, an out-of-frame pixel, or any other pixel from a shift direction and a remaining amount of shift. If the next pixel is a margin pixel, the controller 660 instructs the margin pixel inserting section 666 to insert a margin pixel. If the next pixel is an out-of-frame pixel, the controller 660 instructs the pixel removing section 664 to remove the pixel. If the next pixel is neither a margin pixel nor an out-of-frame pixel, the controller 660 instructs the pixel value buffer 662 to output the pixel value held therein.

The pixel removing section 664, when instructed to remove the pixel value from the pixel shift controller 660, removes the pixel value held in the pixel value buffer 662.

The margin pixel inserting section 666, when instructed to insert a margin pixel from the pixel shift controller 660, outputs one pixel value corresponding to a margin. The pixel value corresponding to a margin is, for example, 0, which is prepared in advance.

The pixel value buffer 662, when instructed to output the pixel value from the pixel shift controller 660, outputs the pixel value held therein. That is, by shifting the output timing of the pixel value held in the pixel value buffer 662, translation of pixels is performed.

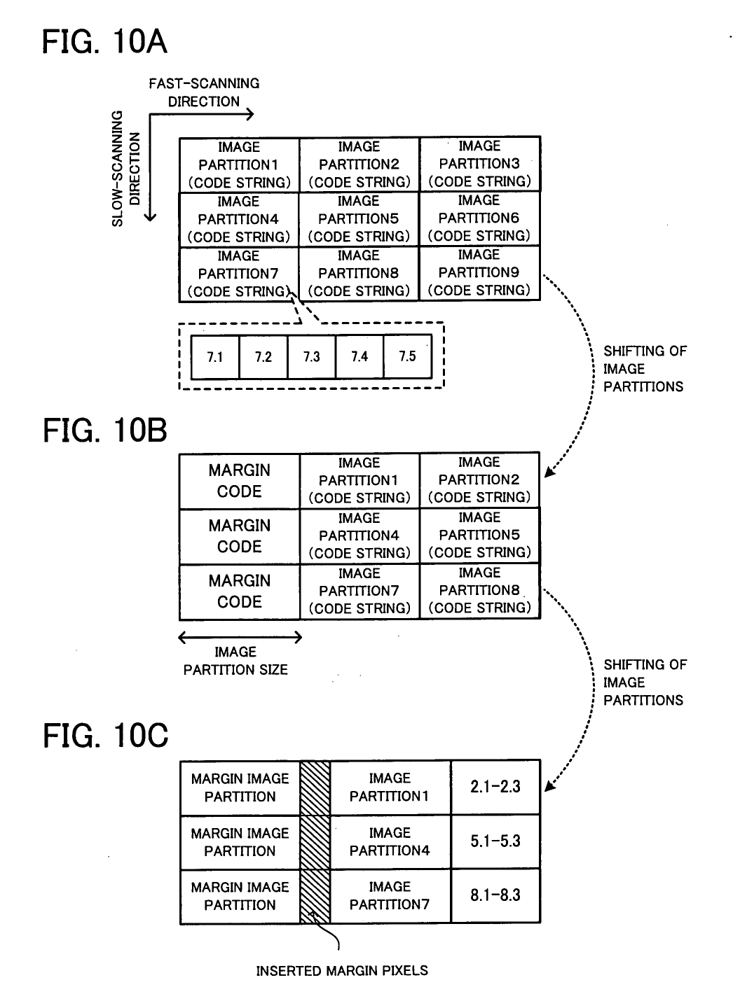

FIGS. 10A to 10C illustrate shift processing. These figures illustrate an instance where an image is shifted by five pixels in the fast-scanning direction.

As illustrated in FIG. 10A, image partitions may be defined as horizontal/vertical image divisions in both fast-scanning direction and slow-scanning direction, when shift processing is performed. In the present exemplary embodiment, an image is divided into three equal image portions in both fast-scanning direction and slow-scanning direction and these portions are regarded as image partitions. In the present exemplary embodiment, four pixels are arranged in the fast-scanning direction within one image partition.

The image partitions manipulating part 62 performs shift processing on the image partition level, as illustrated in FIG. 10B. In the present exemplary embodiment, because shifting by five pixels in the fast-scanning direction is required, shifting by one image partition and shifting by one pixel are performed. As processing to shift by one image partition, one margin code string is inserted at the head in the fast-scanning direction. Thereby, an image partition 1, an image partition 2, and other partitions shift by one image partition downstream in the fast-scanning direction (toward the right in FIG. 10B). Then, code strings of an image partition 3, an image partition 5, and an image partition 8 are removed as those in out-of-frame portions.

Then, the decoding part 54 serially decodes code strings which are serially input from the image partitions manipulating part 62 and outputs a set of decoded values of pixels to the pixels manipulating part 66. Margin codes are decoded to pixel values corresponding to margins.

The pixels manipulating part 66 shifts sets of values of pixels which are input from the decoding part 54 by a remaining amount of shift on the pixel level.

Specifically, the pixels manipulating part 66 inserts margin pixels in the sets of values of pixels input from the decoding part 54 and removes out-of-frame pixels (the last pixels of an image partition 2, an image partition 5, and an image partition 8), if they exist, as illustrated in FIG. 10C.

As above, desired shift processing is realized by combination of shift processing on the image partition level (processing on codes) and shift processing on the pixel level (processing on pixels).

### Third Exemplary Embodiment

Next, an embodiment for combining plural input images is described as a third exemplary embodiment.

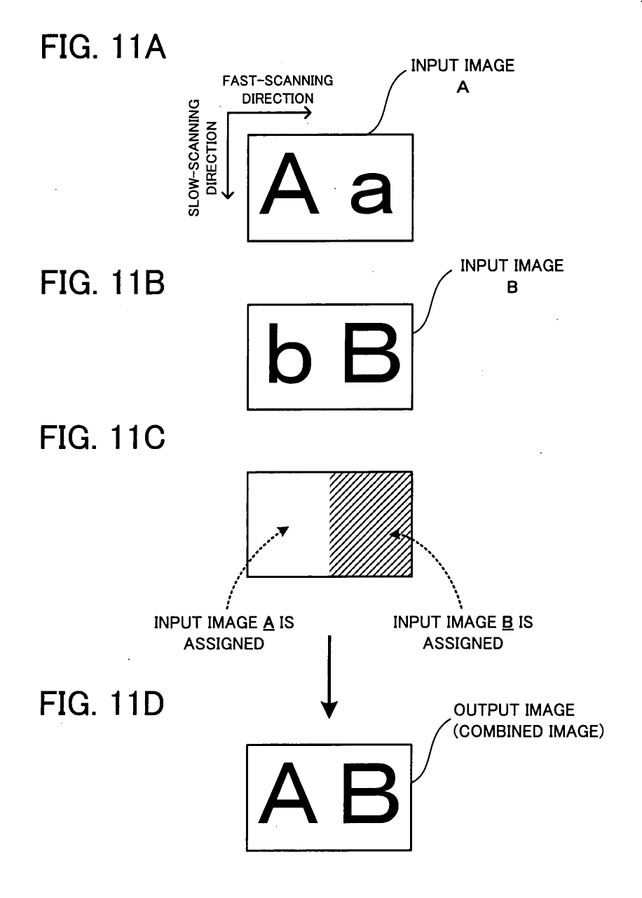

Sometimes, an input image A which is illustrated in FIG. 11A and an input image B which is illustrated in FIG. 11B may be combined into an output image (combined image) which is illustrated in FIG. 11D. In this case, tag information which is illustrated in FIG. 11C is used as information to specify a combining method. Tag information in the present exemplary embodiment is an binary image, wherein one value indicates the assignment of the input image A and the other value indicates the assignment of the input image B. That is, the tag information in the present exemplary embodiment indicates that the input image A is assigned for the left half of the image and the input image B is assigned for the right half of the image.

In the present exemplary embodiment, such combine processing (merge processing) is realized by combination of combine processing on the image partition level and combine processing on the pixel level. The framework of the image forming system 1 and relevant configurations are substantially the same as described for the first exemplary embodiment.

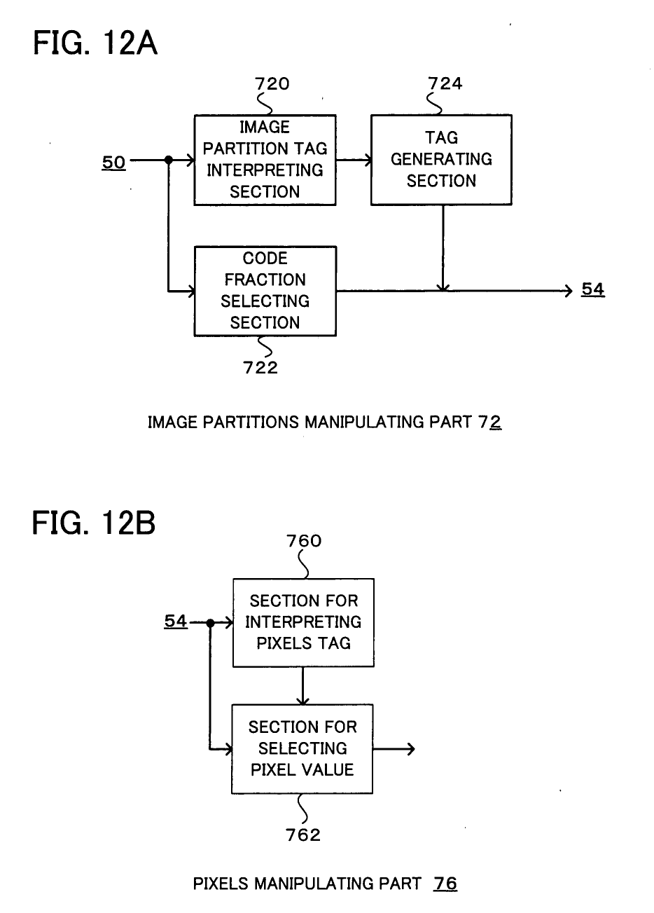

FIG. 12A illustrates an organization of functions of an image partitions manipulating part 72 in the present exemplary embodiment. FIG. 12B illustrates an organization of functions of a pixels manipulating part 76 in the present exemplary embodiment. An image processing program 7 in the present exemplary embodiment is configured such that the image partitions manipulating part 52 and the pixels manipulating part 56 in the image processing program 5 of FIG. 2 is replaced by the image partitions manipulating part 72 and the pixels manipulating part 76 in the present exemplary embodiment, respectively.

As illustrated in FIG. 12A, the image partitions manipulating part 72 includes an image partition tag interpreting section 720, a code fraction selecting section 722, and a tag generating section 724.

The image partition tag interpreting section 720 extracts tag information for each image partition and determines which code string to select from code data of plural input images. The image partition tag interpreting section 720 outputs the extracted tag information to the tag generating section 724.

The code fraction selecting section 722 separates code data of plural input images into code strings corresponding to image partitions, respectively, based on a code book or the like, and selects at least one code string from plural code strings separated, according to the determination made by the image partition tag interpreting section 720.

In the present exemplary embodiment, the image partition tag interpreting section 720, if extracted tag information (tag information for a portion corresponding to an image partition) specifies the input image A only, instructs the code fraction selecting section 722 to select a code string of the input image A. According to this instruction, the code fraction selecting section 722 selects a code string of the input image A from plural code strings separated and outputs the selected code string to the decoding part 54. Likewise, if the tag information specifies the input image B only, the image partition tag interpreting section 720 instructs to select a code string of the input image B and, according to this instruction, the code fraction selecting section 722 selects a code string of the input image B and outputs the selected code string to decoding part 54. If the extracted tag information (tag information for a portion corresponding to an image partition) includes both tag A specifying the input image A and tag B specifying the input image B, the image partition tag interpreting section 720 instructs the code fraction selecting section 722 to select a code string of the input image A and a code string of the input image B. According to this instruction, the code fraction selecting section 722 selects a code string of the input image A and a code string of the input image B from plural code strings separated and outputs the selected code strings to the decoding part 54.

The tag generating section 724 generates tag information (tag on a pixel-by-pixel basis) for combine processing on the pixel level, based on tag information which has been input from the image partition tag interpreting section 720, and outputs a pixels tag generated to the pixels manipulating part 76.

As illustrated in FIG. 12B, the pixels manipulating part 76 includes a section for interpreting pixels tag 760 and a section for selecting pixel value 762.

The section for interpreting pixels tag 760 extracts a tag for each pixel from input tag information and determines per pixel which pixel value to select from a set of plural pixel values which has been input from the decoding part 54, based on the extracted tag.

The section for interpreting pixels tag 760 in the present exemplary embodiment determines which pixel value to select from the pixel values of the respective images (pixel value of the input image A and pixel value of the input image B), input from the decoding part 54, based on the pixels tag generated by the tag generating section 724.

The section for selecting pixel value 762 selects per pixel a pixel value to assign from a set of plural pixel values which has been input from the decoding part 54. In doing so, if there are only pixel values of a single image (that is, if a code string of input image A or input image B has been selected on the image partition level), the section for selecting pixel value 762 outputs the present pixel values unconditionally as they are.

The section for selecting pixel value 762 in the present exemplary embodiment outputs the pixel values as they are for an image partition where only pixel values of input image A or input image B exist. For an image partition where pixel values of both input image A and input image B exist, the section for selecting pixel value 762 selects per pixel either a pixel value of input image A or a pixel value of input image B, based on the pixels tag generated by the tag generating section 724, and outputs the selected values of the pixels.

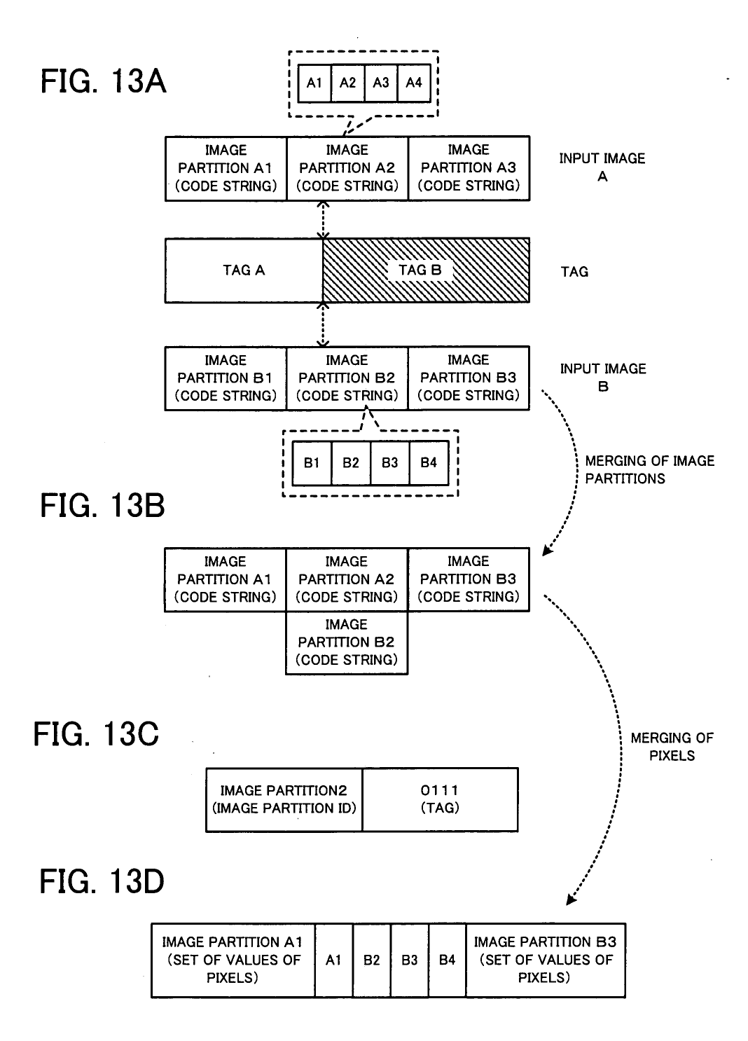

FIGS. 13A to 13D illustrate combine processing (merge processing). Although these figures illustrate a concrete example where two input images are merged, it is possible to merge three or more input images in a similar manner.

As illustrated in FIG. 13A, image partitions may be defined as horizontal/vertical image divisions in both fast-scanning and slow-scanning directions, when combine processing is performed. In the present exemplary embodiment, one line in the fast-scanning direction is divided into tree equal image portions along the same direction and these portions are regarded as image partitions. These image partitions are defined for each of plural input images (input image A and input image B) and four pixels (A1 to A4, B1 to B4) are arranged in the fast-scanning direction within one image partition.

Tag information exists for respective pixels. In the present exemplary embodiment, tag A that specifies input image A only exists for an image portion corresponding to image partition 1 (image partition A1 and image partition B1), both tag A that specifies input image A and tag B that specifies input image B coexist for an image portion corresponding to image partition 2, and tag B that specifies input image B only exists for an image portion corresponding to image partition 3.

The image partitions manipulating part 72 merges image partitions, as illustrated in FIG. 13B. Specifically, the image partition tag interpreting section 720 reads tag information for each image partition and, if the read tag information is only the tag of input image A, causes the code fraction selecting section 722 to select a code string corresponding to an image partition of input image A (the code string of image partition A1 in the present exemplary embodiment). If the read tag information includes both the tag of input image A and the tag of input image B, the image partition tag interpreting section 720 causes the code fraction selecting section 722 to select code strings of input image A and input image B (the code string of image partition A2 and the code string of image partition B2 in the present exemplary embodiment). If the read tag information is only the tag of input image B, the image partition tag interpreting section 720 causes the code fraction selecting section 722 to select a code string of input image B (the code string of image partition B3 in the present exemplary embodiment). The code fraction selecting section 722 may output two streams of selected code strings to the decoding part 54, as illustrated in FIG. 13B, or may merge the code strings into one stream and output the one stream to the decoding part 54.

The image partition tag interpreting section 720 in the present exemplary embodiment instructs the tag generating section 724 to generate a pixels tag, only if the read tag information includes both the tag of input image A and the tag of input image B. According to this instruction, the tag generating section 724 generates a pixels tag including information for identifying an image partition (image partition ID) and tag information within the image partition, as illustrated in FIG. 13C. The tag generating section 724 may generate a pixels tag only for an image partition in which pixels need to be merged, as illustrated in FIG. 13C, or output existing tag information as a pixels tag.

Then, the decoding part 54 serially decodes code strings which are serially input from the image partitions manipulating part 72 and outputs a set of decoded values of pixels to the pixels manipulating part 76.

The pixels manipulating part 76 merges pixels within a set of values of pixels which is input from the decoding part 54.

Specifically, the section for interpreting pixels tag 760 identifies an image partition (image partition 2 in the present exemplary embodiment) in which the pixels are merged, based on the pixels tag illustrated in FIG. 13C, and merges the pixels in the identified image partition according to the tag, thus realizing merge processing on the pixel level, as illustrated in FIG. 13D.

As above, combine processing (merge processing) is realized by combination of merging image partitions (processing on codes) and merging pixels (processing on pixel values).

### Fourth Exemplary Embodiment

Next, an embodiment in which the above plural types of image processing can be executed is described as a fourth exemplary embodiment. The framework of the image forming system 1 and relevant configurations are substantially the same as described for the first exemplary embodiment.

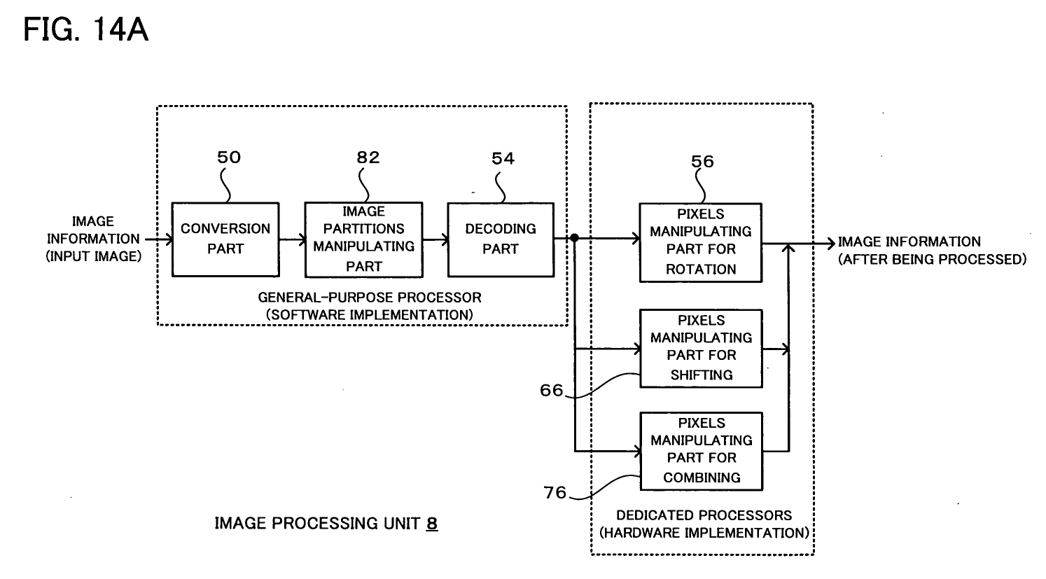

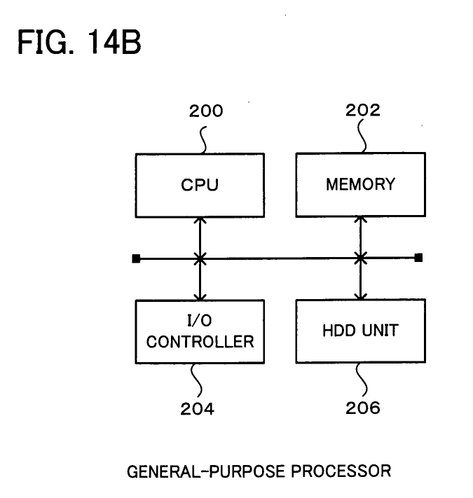

FIG. 14A illustrates an organization of functions of an image processing unit 8 provided in an image processing apparatus of the present exemplary embodiment. FIG. 14B illustrates a hardware configuration of a general-purpose processor in the image processing unit 8. Components shown in these figures which are substantially the same as the components shown in FIG. 2, FIGS. 9A and 9B, or FIGS. 12A and 12B are assigned the same reference numerals.

As illustrated in FIG. 14, the image processing unit 8 includes a code conversion part 50, an image partitions manipulating part 82, a decoding part 54, a pixels manipulating part 56 for rotation, a pixels manipulating part 66 for shifting, and a pixels manipulating part 76 for combining.

The code conversion part 50, the image partitions manipulating part 82, and the decoding part 54 in the present exemplary embodiment are implemented using a general-purpose processor such as a central processing unit (CPU) which is commonly used and software.

The pixels manipulating part 56 for rotation, the pixels manipulating part 66 for shifting, and the pixels manipulating part 76 for combining in the present exemplary embodiment are implemented using dedicated processors such as application specific integrated circuits (ASIC).

In the image processing unit 8, image partitions manipulating part 82 realizes, by software, the functions of the image partitions manipulating part 52 illustrated in FIG. 3 (for rotation processing of image partitions), the functions of the image partitions manipulating part 62 illustrated in FIG. 9A (for shift processing of image partitions), and the functions of the image partitions manipulating part 72 illustrated in FIG. 12A (for merge processing of image partitions).

The image partitions manipulating part 82 in the present exemplary embodiment performs rotation, shift, or merge processing on code strings on the image partition level, according to requested image processing (rotate, shift, or merge).

As illustrated in FIG. 14B, for example, the general-purpose processor is made up of a CPU (Central Processing Unit) 200, a memory 202 such as a RAM (Random Access Memory) or a ROM (Read Only Memory), an I/O controller 204 for control of data input/output, and a hard disk drive unit (HDD unit) 206. A computer program product which is embodied in a computer-readable medium) for realizing the code conversion part 50, the image partitions manipulating part 82, and the decoding part 54 is, for example, loaded to the memory 202 and executed by the CPU 200.

The pixels manipulating part 56 for rotation is a dedicated processor to realize the functions of the pixels manipulating part 56 (rotation processing of pixels) illustrated in FIG. 2. In the present exemplary embodiment, processing for 90-degree rotation and processing for 180-degree rotation on the pixel level is realized by the pixels manipulating part 56 for rotation; however, a dedicated processor for processing for 90-degree rotation and a dedicated processor for processing for 180-degree rotation may be provided separately.

The pixels manipulating part 66 for shifting is a dedicated processor to realize the functions of the pixels manipulating part 66 (shift processing of pixels) illustrated in FIG. 9.

The pixels manipulating part 76 for combining is a dedicated processor to realize the functions of the pixels manipulating part 76 (merge processing of pixels) illustrated in FIG. 12.

Next, operation of the image processing apparatus 2 (image processing unit 8) is described.

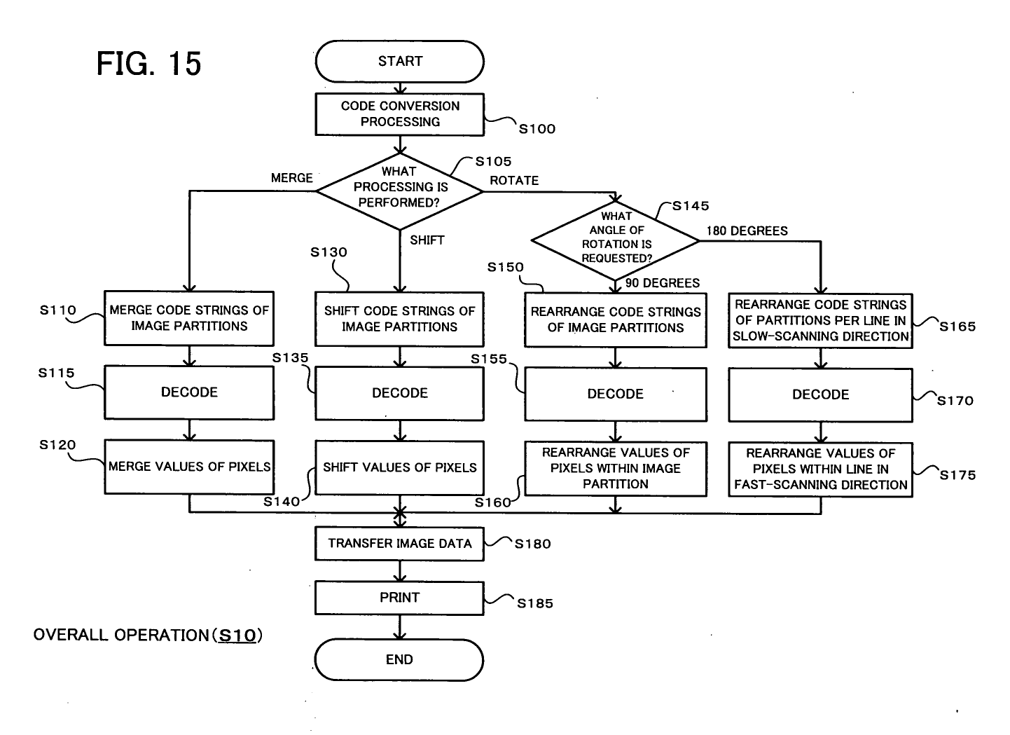

FIG. 15 is a flowchart illustrating the operation (S10) of the image processing apparatus 2 (image processing unit 8).

As illustrated in FIG. 15, at step 100 (S100), the image processing apparatus 2 (FIG. 1), upon receiving code data of an image and information for image processing instructions from a user terminal 92, starts image processing on the received code data according to the information for image processing instructions. In the present exemplary embodiment, an embodiment in which what image processing is performed is specified by the user is described as a concrete example; however, this is not restrictive. For example, the image processing apparatus 2 may determine what image processing is performed by comparing the size of an input image and the size of an output image (imaging paper size).

The code conversion part 50 of the image processing unit 8 (FIG. 14) converts the received code data into code data that can be decoded independently for each of image partitions defined as horizontal/vertical image divisions in fast-scanning and slow-scanning directions and outputs the converted code data to the image partitions manipulating part 82.

At step 105 (S105), the image partitions manipulating part 82 (FIG. 14) determines what image processing is performed on the code data input from the code conversion part 50, based on the information for image processing instructions.

The image processing unit 8 proceeds to step S110 if merge processing is performed; step S130 if shift processing is performed; or step S145 if rotation processing is performed.

At step 110 (S110), the image partitions manipulating part 82 merges code strings (code data for portions corresponding to image partitions) of plural input images, based on tag information attached to the code data. Specifically, as illustrated in FIGS. 13A and 13B, the image partitions manipulating part 82, if only one type of tag information (tag A or tag B only) exists for an image partition, selects only a code string of the input image specified by the tag for this image partition; if two or more types of tags (tag A and tag B) coexist for an image partition, the image partitions manipulating part 82 selects all code strings of these plural input images and generates a pixels tag (FIG. 13C) for this image partition. This step of processing may be performed by the general-purpose processor, because the amount of processing is not much, though the reference range is wide and complex.

At step 115 (S115), the decoding part 54 decodes code data (merged on the image partition level) which is input from the image partitions manipulating part 82 and outputs a set of decoded values of pixels and a pixels tag input from the image partitions manipulating part 82 to the pixels manipulating part 76 for combining.

At step 120 (S120), the pixels manipulating part 76 for combining merges pixels within a set of values of pixels input from the decoding part 54, according to the input pixels tag, as illustrated in FIGS. 13C and 13D.

This step of processing may be performed by the dedicated processor, because the amount of processing may become large on account of processing on the pixel level, though the reference range is limited within a partition and the processing is simple.

At step 130 (S130), the image partitions manipulating part 82 shifts code strings of image partitions according to a shift direction and a shift amount. Specifically, inserting margin codes, removing out-of-frame portions, and thereby shifting the code strings are performed, as illustrated in FIGS. 10A and 10B. At this stage, all required shift processing is not completed and shifting is performed only to the possible extent on the image partition level. The image partitions manipulating part 82 calculates a remaining amount of shift and notifies the pixels manipulating part 66 for shifting of the shift direction and the remaining amount of shift.

This step of processing may be performed by the general-purpose processor, because the amount of processing is not large, though the reference range is wide and complex.

At step 135 (S135), the decoding part 54 decodes code data (shifted on the image partition level) which is input from the image partitions manipulating part 82 and outputs a set of decoded values of pixels to the pixels manipulating part 66 for shifting.

At step 140 (S140), the pixels manipulating part 66 for shifting adds margin pixels and removes out-of-frame pixels for sets of values of pixels input from the decoding part 54, according to the shift direction and the remaining amount of shift, as illustrated in FIG. 10C. Thereby, shift processing on the pixel level is performed.

This step of processing may be performed by the dedicated processor, because the amount of processing may become large on account of processing on the pixel level, though the reference range is relatively narrow and the processing is simple.

At step 145 (S145), the image partitions manipulating part 82 (FIG. 14) determines whether processing for 90-degree rotation or 180-degree rotation is performed on code data input from the code conversion part 50.

The image processing unit 8 proceeds to step S150 if processing for 90-degree rotation is performed or step 165 if processing for 180-degree rotation is performed.

At step 150 (S150), the image partitions manipulating part 82 rotates code strings of image partitions by 90 degrees. Specifically, the image partitions manipulating part 82 rearranges the code strings corresponding to the image partitions to make a 90-degree rotation on the image partition level, as illustrated in FIGS. 5A and 5B.

This step of processing may be performed by the general-purpose processor, because the amount of processing is not large, though the reference range is wide and complex.

At step 155 (S155), the decoding part 54 decodes code data (rotated by 90 degrees on the image partition level) which is input from the image partitions manipulating part 82 and outputs a set of decoded values of pixels to the pixels manipulating part 56 for rotation.

At step 160 (S160), the pixels manipulating part 56 for rotation rotates a set of values of pixels input from the decoding part 54 by 90 degrees within the image partition containing these pixels. Specifically, the pixels manipulating part 56 for rotation writes a set of values of pixels contained in an image partition into a block line buffer and reads the values of pixels from the block line buffer in a sequence in accordance with the rotation direction, as illustrated in FIGS. 5C and 5D.

This step of processing may be performed by the dedicated processor, because the amount of processing may become large on account of processing on the pixel level, though the reference range is relatively narrow and the processing is simple.

At step 165 (S165), the image partitions manipulating part 82 assembles image partitions per line in the fast-scanning direction and these image partitions are to be rotated by 180 degrees.

The image partitions manipulating part 82 rotates the code strings of the image partitions by 180 degrees. Specifically, the image partitions manipulating part 82 rearranges the code strings corresponding to the image partitions in the slow-scanning direction, as illustrated in FIGS. 4A and 4B.

This step of processing may be performed by the general-purpose processor, because the amount of processing is not large, though the reference range is wide and complex.

At step 170 (S170), the decoding part 54 decodes code data (rotated by 180 degrees on the image partition level) which is input from the image partitions manipulating part 82 and outputs a set of decoded values of pixels to the pixels manipulating part 56 for rotation.

At step 175 (S175), the pixels manipulating part 56 for rotation rotates a set of values of pixels input from the decoding part 54 by 180 degrees within the image partition containing these pixels. Specifically, the pixels manipulating part 56 for rotation writes a set of values of pixels contained in an image partition into a line buffer and reads these values of pixels from the line buffer in a sequence reverse to the writing sequence, as illustrated in FIGS. 4C and 4D.

This step of processing may be performed by the dedicated processor, because the amount of processing may become large on account of processing on the pixel level, though the reference range is relatively narrow and the processing is simple.

At step 180 (S180), the values of pixels which are output from the pixels manipulating part 56 for rotation, the pixels manipulating part 66 for shifting, or the pixels manipulating part 76 for combining are transferred to the printer 3 (FIG. 1).

At step 185 (S185), the printer 3 prints an image on imaging paper, based on the transferred values of pixels.

The present invention may be embodied in other specific forms without departing from its spirit or characteristics. The described exemplary embodiments are to be considered in all respects only as illustrated and not restrictive. The scope of the invention is, therefore, indicated by the appended claims rather than by the foregoing description. All changes that come within the meaning and range of equivalency of the claims are to be embraced within their scope.

What is claimed is:

1. An image processing apparatus comprising:
an image partitions manipulating unit that manipulates image partitions of encoded image information, each image partition containing a plurality of values of pixels;
a decoding unit that decodes the image information manipulated by the image partitions manipulating unit; and
a pixels manipulating unit that manipulates pixels of the image information decoded by the decoding unit,
partitioning an image into partitions which are manipulated by the image partitions manipulating unit being changed according to what manipulation is to be performed by the pixels manipulating unit.

2. The image processing apparatus according to claim 1,
wherein each of the image partitions is an image portion for which code data can be decoded independently of other image portions; and
the image partitions manipulating unit manipulates image portions for each of which code data can be decoded independently of other image portions.

3. The image processing apparatus according to claim 1, further comprising a code conversion unit that makes conversion into code that is independent for each of the image partitions,
wherein the image partitions manipulating unit manipulates the code converted by the code conversion unit.

4. The image processing apparatus according to claim 1,
wherein the image partitions manipulating unit rearranges the image partitions of the image information in a sequence to obtain an angle of rotation of an image; and
the pixels manipulating unit rearranges image information rearranged by the image partitions manipulating unit in a sequence to obtain the angle of rotation of the image.

5. The image processing apparatus according to claim 4,
wherein when an image is rotated by 90 degrees, the image partitions are defined as image portions into which at least image length in a fast-scanning direction is divided;
the image partitions manipulating unit rearranges fractions of image information encoded for each of the image portions; and
the pixels manipulation unit rearranges values of pixels within an image portion.

6. The image processing apparatus according to claim 4,
wherein when an image is rotated by 180 degrees, the image partitions are defined as image portions into which at least image length in a slow-scanning direction is divided;
the image partitions manipulating unit rearranges the sequence of the image portions at least in the slow-scanning direction; and
the pixels manipulation unit rearranges the sequence of pixels within an image portion at least in the fast-scanning direction.

7. The image processing apparatus according to claim 1,
wherein when an image position is shifted, the image partitions manipulating unit shifts the image partitions of encoded image information; and
the pixels manipulation unit shifts pixels of decoded image information.

8. The image processing apparatus according to claim 1,
wherein if a plurality of encoded images are input, the image partitions manipulating unit selects encoded information for at least one image for each image portion; and
for an image portion for which respective information fractions for the plurality of images are selected, the pixels manipulation unit selects a pixel value to be applied for each pixel from the selected information fractions for the plurality of images.

9. The image processing apparatus according to claim 1,
wherein the image partitions manipulating unit is realized by a general-purpose processor; and
the pixels manipulation unit is realized by a dedicated processor.

10. An image processing apparatus comprising:
an image partitions manipulating unit that manipulates image partitions of encoded image information, each image partition containing a plurality of values of pixels;
a decoding unit that decodes the image information manipulated by the image partitions manipulating unit; and
a plurality of dedicated processors that are assigned, respectively, to perform processing tasks for a plurality of types of image processing on image information decoded by the decoding unit.

11. An image forming apparatus comprising:
an image partitions manipulating unit that manipulates image partitions of encoded image information, each image partition containing a plurality of values of pixels;
a decoding unit that decodes the image information manipulated by the image partitions manipulating unit;
a pixels manipulating unit that manipulates pixels of the image information decoded by the decoding unit; and
an image forming unit that forms an image based on the image information manipulated by the pixels manipulating unit,
partitioning an image into partitions which are manipulated by the image partitions manipulating unit being changed according to what manipulation is to be performed by the pixels manipulating unit.

12. An image forming system comprising:
an image processing apparatus that performs image processing on image information; and
an image forming apparatus that forms an image based on image information processed by the image processing apparatus,
the image processing apparatus including:
an image partitions manipulating unit that manipulates image partitions of encoded image information, each image partition containing a plurality of values of pixels;
a decoding unit that decodes the image information manipulated by the image partitions manipulating unit; and
a pixels manipulating unit that manipulates pixels of the image information decoded by the decoding unit,
partitioning an image into partitions which are manipulated by the image partitions manipulating unit being changed according to what manipulation is to be performed by the pixels manipulating unit.

13. A computer readable medium storing a program causing a computer to execute a process comprising:
defining partitioning an image into image partitions, each containing a plurality of values of pixels, based on what manipulation is to be performed for pixels of image information;
manipulating the defined image partitions of encoded image information;
decoding image information manipulated in terms of the image partitions; and
manipulating pixels of decoded image information.

14. An image processing method comprising:
putting a plurality of information values to be compressed together and generating a group of information values to be compressed;
assigning a code to each generated group; and
encoding the information values to be compressed belonging to each group, using the code assigned to each group.

15. A computer data signal embodied in a carrier wave for enabling a computer to perform a process comprising:
putting a plurality of information values to be compressed together and generating a group of information values to be compressed;
assigning a code to each generated group; and
encoding the information values to be compressed belonging to each group, using the code assigned to each group.
